(19) United States
(12) Patent Application Publication
(10) Pub. No.: US 2017/0195995 A1
(43) Pub. Date: Jul. 6, 2017

(54) DEVICE-TO DEVICE (D2D) SYNCHRONIZATION MESSAGE SIGNALING

(71) Applicant: FUJITSU LIMITED, Kawasaki-shi (JP)

(72) Inventor: Chenxi ZHU, Fairfax, VA (US)

(73) Assignee: FUJITSU LIMITED, Kawasaki-shi (JP)

(21) Appl. No.: 15/468,007

(22) Filed: Mar. 23, 2017

Related U.S. Application Data
(63) Continuation of application No. PCT/US2015/017777, filed on Feb. 26, 2015.
(60) Provisional application No. 62/054,188, filed on Sep. 23, 2014.

(51) Int. Cl. H04W 72/04; H04W 8/00; H04W 56/00

(52) U.S. Cl. CPC H04W 72/04; H04W 56/001; H04W 8/005

(57) ABSTRACT

A method includes a first user equipment (UE) selecting one or more resource pools from multiple resource pools. The method includes the first UE transmitting a resource usage indicator that identifies the one or more resource pools to a second UE. The method includes the first UE transmitting one or more D2D communications to the second UE using the one or more resource pools.

### FIELD

The present disclosure relates to device-to-device (D2D) synchronization message signaling.

### BACKGROUND

Device-to-device (D2D) communication may allow data transmissions to be made directly between two or more devices or terminals of a telecommunication system. The D2D communication may overlay regular cellular communications, and may be performed with or without cellular network coverage.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method includes a first user equipment (UE) selecting one or more resource pools from multiple resource pools. The method includes the first UE transmitting a resource usage indicator that identifies the one or more resource pools to a second UE. The method includes the first UE transmitting one or more D2D communications to the second UE using the one or more resource pools.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram of an example telecommunication system;

FIG. 2 is a flowchart of an example method to reduce detection overhead of messages in resource pools; and

FIG. 3 is a block diagram illustrating an example computing device in which the method of FIG. 2 may be implemented.

### DESCRIPTION OF EMBODIMENTS

Some embodiments as herein described may relate to a communication system based on the 3rd Generation Partnership Project's (3GPP) Long Term Evolution (LTE) radio access network. Descriptions involving LTE may also apply to 3GPP's Long Term Evolution Advanced (LTE-A) radio access network. However, the embodiments described herein are not limited to the example communication systems described. Rather, the embodiments described herein may be applicable to other communication systems as well.

Future releases of LTE/LTE-A standards are expected to support device-to-device (D2D) communication. For example, it is anticipated that LTE-A releases 12 and 13 will support D2D communication allowing a user equipment (UE) to transmit directly to another UE. The D2D communication may support discovery between UEs.

In some instances, using D2D communication may increase network capacity. For example, D2D communication may permit spatial multiplexing, which may allow for higher relative spectrum usage. Employing D2D communication may also permit throughput between devices to be increased if a D2D link experiences better channel quality than a cellular link. Using D2D communication may reduce resource usage when data is transmitted once between two devices during a D2D transmission, as compared to transmitting the same data twice between the two devices over a cellular link, i.e., once through an uplink (UL) transmission from a transmitting device to a base station and once through a downlink (DL) transmission to a receiving device from the base station.

Device-to-device communication may reduce communication latency of a telecommunication network. For example, D2D communication may not relay data through a base station and/or a core network, thus potentially reducing the transit time of the data and/or the load on the base station and/or the core network.

Each UE may be configured with a limited number of resources pools when acting as a D2D-transmitting UE. For example, for D2D transmission, each UE may be configured with up to four resource pools for D2D discovery (hereinafter “D2D discovery resource pools” or “D2D discovery resource pool”), up to four resource pools for mode 2 D2D scheduling assignment (SA) (hereinafter “D2D SA resource pools” or “D2D SA resource pool”), and/or up to four resource pools for D2D data (hereinafter “D2D data resource pools” or “D2D data resource pool”).

As a particular example, a first UE may act as a D2D-transmitting UE and may be configured with a first set of D2D discovery resource pools from which to select a particular D2D discovery resource pool for D2D discovery transmissions (or messages), a second set of D2D SA resource pools from which to select a particular D2D SA resource pool for D2D SA transmissions (or messages), and a third set of D2D data resource pools from which to select a particular D2D data resource pool for D2D data transmissions (or messages). A second UE may also act as a D2D-transmitting UE and may be configured with a fourth set of D2D discovery resource pools from which to select a particular D2D discovery resource pool for D2D discovery transmissions, a fifth set of D2D SA resource pools from which to select a particular D2D SA resource pool for D2D SA transmissions, and a sixth set of D2D data resource pools from which to select a particular D2D data resource pool for D2D data transmissions. A third UE may act as a D2D-receiving UE and may monitor each resource pool of the first, second, third, fourth, fifth, and sixth sets of resource pools to monitor for D2D discovery, SA, and data transmissions from the first and second UEs.

However, in this example, the reception complexity and the power consumption by the third UE may be higher than needed for receiving the D2D discovery, SA, and data transmissions from the first and second UEs. As already mentioned, the first and second UEs may select a particular D2D discovery, SA, and data resource pool from the first, second, third, fourth, fifth, and sixth sets of resource pools for D2D discovery, SA, and data transmissions. Thus, to the extent the third UE monitors all of the resource pools in each of the first, second, third, fourth, fifth, and sixth sets of resource pools, or even any additional resource pools beyond the particular resource pools selected by the first and second UEs, the third UE may monitor more resource pools than are actually being used for D2D discovery, SA, and data transmissions.

In contrast, some embodiments disclosed herein may reduce reception complexity and power consumption by receiving UEs. In an example embodiment, a D2D-transmitting UE selects a resource pool from multiple resource pools for transmitting a D2D transmission, such as a D2D discovery transmission, a D2D SA transmission, and/or a D2D data transmission. The D2D-transmitting UE may transmit a resource usage indicator configured to identify which resource pool was selected. The resource usage indicator may be transmitted over a D2D synchronization channel or the like. A D2D-receiving UE may receive the resource usage indicator and may monitor the resource pool selected by the D2D-transmitting UE and may ignore those resource pools of the multiple resource pools that are not selected by the D2D-transmitting UE. In particular, the D2D-receiving UE may not monitor the resource pools that are not selected by the D2D-transmitting UE or other D2D-transmitting UEs. Optionally, the D2D-receiving UE may estimate loads on the multiple resource pools based on the resource usage indicator from the D2D-transmitting UE, as well as other resource usage indicators from other D2D-transmitting UEs. Based on the estimated loads, the D2D-receiving UE may select a resource pool for transmitting its own D2D transmissions or messages. For example, the D2D-receiving UE may select a resource pool for transmitting a D2D discovery message or D2D SA message and/or for its own D2D communications to another UE when acting as a D2D-transmitting UE.

In the present disclosure, the term “D2D-transmitting UE” may refer to a UE that transmits D2D transmissions to another UE and the term “D2D-receiving UE” may refer to a UE that receives D2D transmissions from another UE. A UE may take on a D2D transmitting or receiving role at different times and/or with respect to different UEs. Therefore, the same UE may be considered a D2D-transmitting UE and a D2D-receiving UE in some instances depending on the role(s) it is playing.

Reference will now be made to the drawings to describe various aspects of some example embodiments of the invention. The drawings are diagrammatic and schematic representations of such example embodiments, and are not limiting of the present invention, nor are they necessarily drawn to scale.

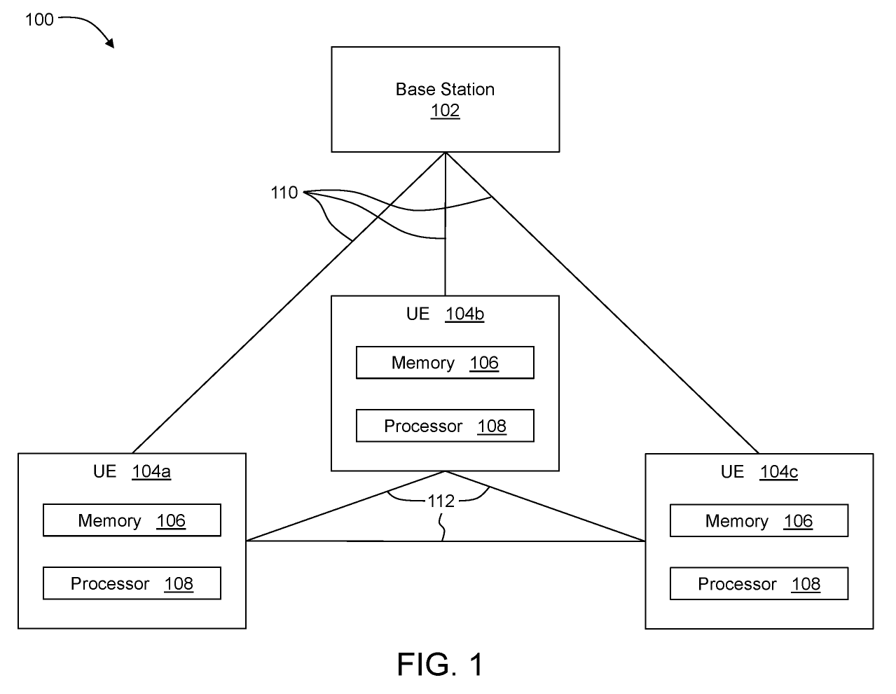

FIG. 1 is a diagram of an example telecommunication system 100, arranged in accordance with at least one embodiment described herein. A network architecture of the telecommunication system 100 may include the network architecture of an Evolved Universal Mobile Telecommunications System (E-UMTS). The E-UMTS may include an LTE radio access network, for instance. The radio access network may include an E-UMTS Terrestrial Radio Access Network (E-UTRAN). However, other types of network architecture may alternately or additionally be used.

The telecommunication system 100 may include a base station 102. The base station 102 may include base station equipment, including hardware and/or software for radio communication with radio-communication-equipped nodes (“wireless nodes”) which may be described herein as devices, terminals, and/or UEs. For example, the base station 102 may be equipped for radio communication 110 with UE 104a, UE 104b, and UE 104c (collectively “UEs 104”). The base station 102 may generally allow the wireless nodes, including the UEs 104, to wirelessly communicate with each other and/or to wirelessly access a network (not shown) via radio communication 110 with the base station 102.

The base station 102 may include hardware and software for radio communication over a licensed spectrum. The licensed spectrum may generally include portions of a radio spectrum licensed for transmission of wireless data, such as cellular data. For example, the base station 102 may be configured to transmit cellular data that complies with an LTE radio access network, such as an LTE radio access network according to the 3GPP LTE specification. In the present disclosure, the term “base station” may include any suitable wireless communication network access point, For example, the base station 102 may include an E-UTRAN NodeB (eNB) associated with LTE radio access networks, a remote radio head (RRH), or any other suitable communication point.

The UEs 104 may include equipment configured to allow the UEs 104 to transmit and receive data via wireless communications via the licensed spectrum. For example, the UEs 104 may include hardware, such as one or more antennas for transmitting and receiving radio transmissions, and codecs. The UEs 104 may include mobile phones, tablet computers, laptop computers, and/or other electronic devices that may use radio communication. Alternately or additionally, the UEs 104 may include devices that employ machine-type communication (MTC).

Each of the UEs 104 may include memory 106 and a processor 108. The memory 106 may include a non-transitory computer-readable medium. Instructions such as programming code executable by the processor 108 may be encoded in the memory 106. When the instructions are executed by the processor 108, the associated UEs 104 may perform operations related to and/or including the processes described herein.

The UEs 104 may be equipped for D2D communication 112. In some embodiments, one or more of the UEs 104 may transmit a D2D synchronization signal (D2DSS) and/or a physical D2D synchronization channel (PD2DSCH), which may provide synchronization to other UEs 104 within transmission range. The D2DSS and/or PD2DSCH from a particular UE may allow time and/or frequency synchronization for the reception of D2D transmissions from a particular UE.

The D2D communication 112 may allow the UEs 104 to perform D2D discovery, schedule D2D data transmissions, transmit D2D data, and/or receive D2D data among the UEs 104 without routing the data through the base station 102. The UEs may perform the D2D communication 112 via time-frequency transmission resources of the telecommunication system 100, described herein as “resources.”

In some instances, the base station 102 may assign resources to the UEs 104 for the D2D communication 112. The UEs 104 that are assigned resources for D2D communication 112 from the base station 102 are described herein as “mode 1” UEs 104.

In some instances, the UEs 104 may select resources for the D2D communication 112. The UEs 104 that select resources for D2D communication 112 are described herein as “mode 2” UEs 104. Mode 2 UEs 104 may include UEs 104 outside of network coverage, which may include UEs 104 outside of a range of the base station 102.

The UEs 104 may be configured with resource pools for various D2D transmissions. The resource pools may be associated with a set of resources via which the UEs 104 may perform some D2D communication transmissions. In some instances the resource pools may be associated with mode 2 D2D communications. The UEs 104 may be configured with multiple resource pools for a particular type of D2D communications and the UE may select a subset of the multiple resource pools for performing the associated D2D communications.

By way of example, each of the UEs 104 may be configured with up to four D2D discovery resource pools for D2D discovery transmissions, up to four D2D SA resource pools for mode 2 D2D scheduling assignment (SA) transmissions, and/or up to four D2D data resource pools for D2D data transmissions. Alternately, each of the UEs 104 may be configured with more or fewer D2D discovery, SA, and/or data resource pools for D2D discovery transmissions, mode 2 D2D SA transmissions, and/or mode 2 D2D data transmissions. Alternately or additionally, each of the UEs 104 may be configured with other resource pools for performing other D2D transmissions. Each of the resource pools may include different resources.

In some instances, the UEs 104 may be configured with more resource pools for D2D reception than for D2D transmission. For example, the UEs 104 may be configured with resource pools from multiple D2D-transmitting UEs 104 configured with different resource pool configurations.

In some embodiments, D2D-transmitting UEs, e.g., the UE 104a and the UE 104b, may transmit a PD2DSCH message including a resource usage indicator configured to indicate which resources each of the D2D-transmitting UEs 104a and 104b intends to use for D2D transmissions until the next PD2DSCH message transmission. Alternately or additionally, the resource usage indicator may include a bitmap including multiple bits, with each bit indicating whether a particular resource pool associated with the corresponding bit has been selected for use. For example, a 0 for a first bit in the bitmap associated with a first resource pool may indicate that the first resource pool has not been selected for use, while a 1 for the first bit in the bitmap may instead indicate that the first resource pool has been selected for use.

Alternately or additionally, in instances where resource pools are used in a particular order, the resource usage indicator may indicate how many resource pools of each type are used. As an example, if up to M resource pools of a particular type can be configured, but a UE can use resource pool N (N<=M) only if resource pools 1, 2, . . . , N−1 are already used, indication of N in PD2DSCH implies that the resource pools are 1, 2, . . . , N.

By way of example, the UE 104a may transmit, e.g., in a PD2DSCH message, a resource usage indicator configured to indicate a D2D discovery resource pool from a set of D2D discovery resource pools assigned to each of the UE 104a, that the UE 104a intends to use for a D2D discovery transmission. Alternately or additionally, the UE 104a may transmit, e.g., in a PD2DSCH message, a resource usage indicator configured to indicate a D2D SA resource pool, from a set of D2D SA resource pools assigned to each of the UE 104a, that the UE 104a intends to use for a D2D SA transmission. Alternately or additionally, the UE 104a may transmit, e.g., in a PD2DSCH message, a resource usage indicator configured to indicate a data transmission resource pool, from a set of D2D data resource pools assigned to each of the UE 104a, that the UE 104a intends to use for a D2D data transmission.

However, in some instances, there may be a one-to-one association between the D2D SA resource pools and the D2D data resource pools. Thus, optionally, the UE 104a may forego transmitting a resource usage indicator for the D2D data resource pool that the UE 104a intends to use for a D2D data transmission, as the receiving UE 104c may derive the D2D data resource pool from the indicated D2D SA resource pool.

A D2D receiving UE, such as the UE 104c, may receive the resource usage indicators and may monitor those resource pools indicated in the resource usage indicators and may ignore those resource pools not indicated in the resource usage indicators. As a result, the UE 104c may monitor a subset of the total possible resource pools, thereby reducing its reception complexity and/or power consumption while still monitoring those resource pools via which D2D transmissions may be received.

In some embodiments, a UE may monitor resource usage indicators for information about resource pool usage and may select resource pools for its D2D transmissions based on the usage information. For example, the resource usage indicators may indicate the relative use and congestion of various resource pools and the UE may select a resource pool experiencing relatively less congestion or the least congestion of all available resource pools. Thus, some degree of spatial reuse may be obtained, which may potentially result in less collisions and higher throughput.

In some instances, a D2D-receiving UE, such as the UE 104c, may use the usage information obtained from the resource usage indicators when the UE 104c has a D2D transmission to send and becomes a D2D-transmitting UE. Alternately or additionally, a D2D-transmitting UE, such as UE 104a, may monitor PD2DSCH messages from other UEs for resource usage indicators before beginning a D2D transmission so that the UE 104a may select resource pools based on usage information. In some instances, a UE that may not be monitoring resource pools for D2D communication 112 may monitor the resource usage indicators to obtain information regarding a D2D network load.

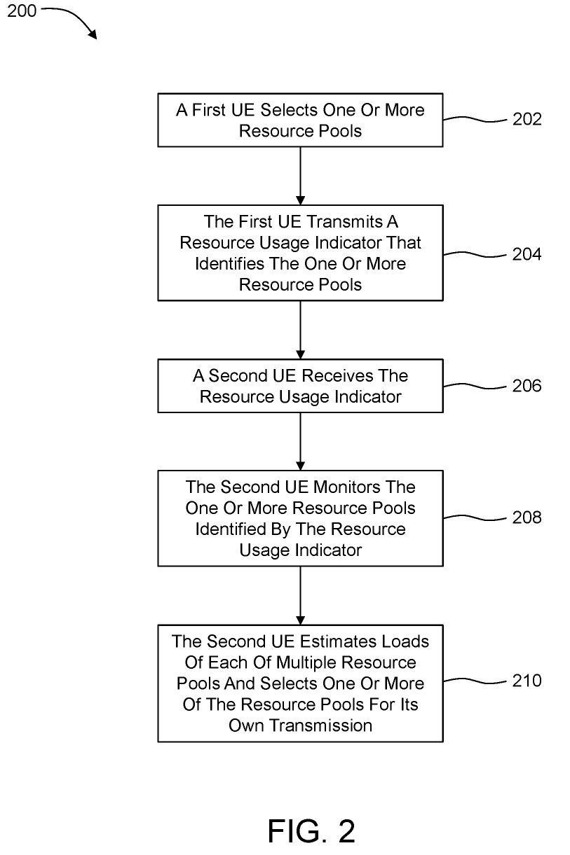

FIG. 2 is a flowchart of an example method 200 to reduce detection overhead of messages in resource pools, arranged in accordance with at least one embodiment described herein. The method 200 may be implemented, in whole or in part, by one or more of the UEs 104 of FIG. 1, or another suitable device, terminal, or UE.

The method 200 may begin at block 202, where a first UE may select one or more resource pools from a set of resource pools. The set of resources pools may be assigned to the first UE for D2D transmissions and/or or may otherwise be available to the first UE. The one or more resource pools may be selected for D2D transmissions to be made by the first UE. The one or more resource pools may include a D2D discovery resource pool via which the first UE will transmit a D2D discovery message and/or a D2D SA resource pool via which the first UE will transmit a D2D SA message. The D2D discovery resource pool may be selected from a set of D2D discovery resource pools. The D2D SA resource pool may be selected from a set of D2D SA resource pools. Thus, the first UE selecting the one or more resource pools from the set of resource pools may include the first UE selecting one or both of the D2D discovery resource pool from the set of D2D discovery resource pools or the D2D SA resource pool from the set of D2D SA resource pools.

In block 204, the first UE may transmit a resource usage indicator. In some embodiments, the first UE transmitting the resource usage indicator may include the first UE transmitting a PD2DSCH message that includes the resource usage indicator. The resource usage indicator may identify the one or more selected resource pools. For example, the resource usage indicator may identify one or both of the selected D2D discovery resource pool and the selected D2D SA resource pool. Alternately or additionally, the resource usage indicator may at least implicitly identify a D2D data resource pool that is associated with the selected D2D SA resource pool.

Although not illustrated in FIG. 2, the method 200 may additionally include the first UE transmitting one or more D2D transmissions using the selected one or more resource pools. For example, the method 200 may include the first UE transmitting a D2D discovery message using the selected D2D discovery resource pool, a D2D SA message using the selected D2D SA resource pool, and/or a D2D data transmission using the D2D data resource pool associated with the selected D2D SA resource pool.

In block 206, a second UE receives the resource usage indicator transmitted by the first UE. In some embodiments, the second UE may receive the resource usage indicator from the PD2DSCH message transmitted by the first UE. The second UE may identify the one or more resource pools selected by the first UE from the resource usage indicator. For example, the second UE may determine the D2D discovery resource pool and/or the D2D SA resource pool selected by the first UE from the resource usage indicator.

In block 208, the second UE may monitor the one or more resource pools selected by the first UE. For example, the second UE may monitor the D2D discovery resource pool and/or the D2D SA resource pool selected by the first UE. The second UE may avoid monitoring, e.g., may ignore, those resource pools not selected by the first UE (and not selected by other UEs in communication with the second UE). For example, the second UE may avoid monitoring or may ignore the D2D discovery resource pools and/or the D2D SA resource pools not selected by the first UE or the other UEs. Detection overhead for the second UE may be reduced by the second UE ignoring (e.g., not monitoring) those resource pools that have not been selected by the first UE. In particular, the second UE may monitor resource pools identified by resource usage indicators received by the second UE without monitoring other resource pools.

In optional block 210, the second UE may estimate loads of various resource pools and select one or more resource pools based at least in part on the estimated loads. The loads may be estimated based on the resource usage indicator from the first UE, as well as other resource usage indicators from other D2D-transmitting UEs. As an example, a UE can estimate the number of times a certain resource pool is used by other UEs (through counting the resource usage indicators in received PD2DSCHs). If it finds a resource pool is heavily used by other UEs, it may avoid using the same resource pool by using a different pool. The one or more resource pools selected by the second UE may be selected for D2D transmissions to be made by the second UE. For example, the one or more resource pools selected by the second UE may include a D2D discovery resource pool and/or a D2D SA resource pool, each of which may be selected based on the estimated loads. For instance, each of the selected one or more resource pools may have a relatively low or even a lowest estimated load out of the set or sets of available resource pools assigned to the second UE. The second UE may use the one or more resource pools it selects for D2D transmissions to be made by the second UE.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed implementations.

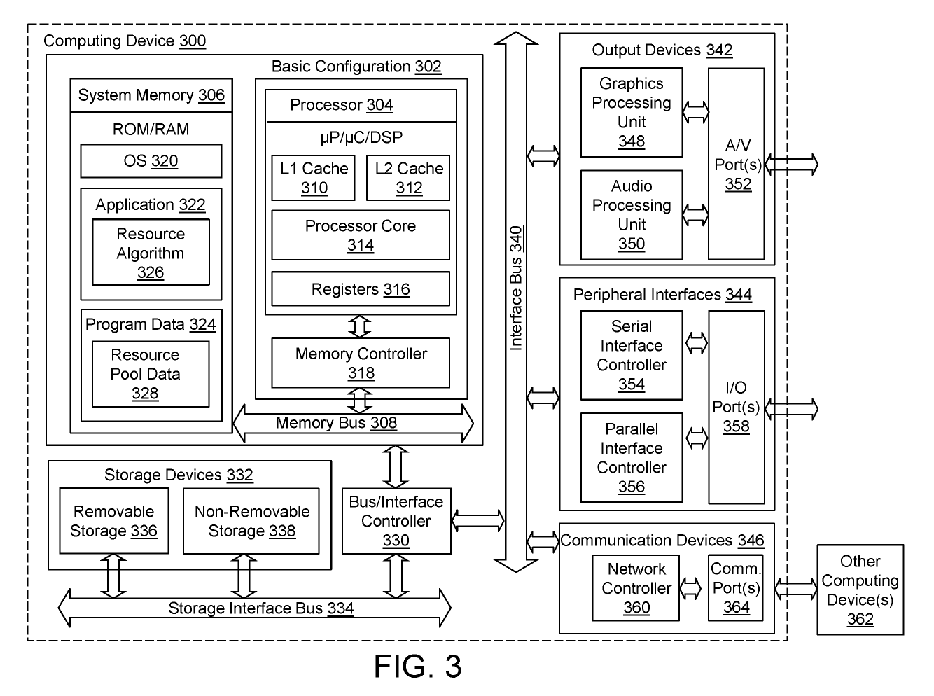

FIG. 3 is a block diagram illustrating an example computing device 300 in which the method 200 of FIG. 2 may be implemented, arranged in accordance with at least one embodiment described herein. In a very basic configuration 302, the computing device 300 may typically include one or more processors 304 and a system memory 306. A memory bus 308 may be used for communicating between the processor 304 and the system memory 306.

Depending on the desired configuration, the processor 304 may be of any type including, but not limited to, a central processing unit (CPU), a microprocessor (μP), a microcontroller (μC), a digital signal processor (DSP), or any combination thereof. The processor 304 may include one or more levels of caching, such as a level one cache 310 and a level two cache 312, a processor core 314, and registers 316. The example processor core 314 may include an arithmetic logic unit (ALU), a floating point unit (FPU), a digital signal processing core (DSP core), or any combination thereof. An example memory controller 318 may also be used with the processor 304, or in some implementations the memory controller 318 may be an internal part of the processor 304.

Depending on the desired configuration, the system memory 306 may be of any type including, but not limited to, volatile memory (such as RAM), non-volatile memory (such as ROM, flash memory), or any combination thereof. The system memory 306 may include an operating system (OS) 320, one or more applications 322, and program data 324. The application 322 may include a resource algorithm 326 that may be arranged to perform one or more of the functions as described herein including those described with respect to the method 200 of FIG. 2. For example, the resource algorithm 326 may be configured to select a resource pool, send a corresponding usage indicator, and use the selected resource pool to send D2D transmissions to a D2D-receiving UE. Alternatively or additionally, the resource algorithm 326 may be configured to receive resource usage indicators from D2D-transmitting UEs, monitor only those resource pools identified by the resource usage indicators, and/or estimate loads of available resource pools to select one or more resource pools for its own D2D transmissions based on the estimated loads.

The program data 324 may include resource pool data 328 that may include or identify resource pools assigned or otherwise available to the computing device 300 for D2D transmissions, a table, map, or other data to identify resource pools based on resource usage indicators received from D2D-transmitting UEs, one or more resource usage indicators received from D2D-transmitting UEs and/or the corresponding resource pools for the computing device 300 to monitor. Alternatively or additionally, the resource pool data 328 may include estimated loads of the resource pools assigned or otherwise available to the computing device 300 for D2D transmissions, and/or an indication of one or more of the resource loads selected by the computing device 300, based on the estimated loads, to use for D2D transmissions of its own.

In some embodiments, the application 322 may be arranged to operate with the program data 324 on the OS 320 such that implementations of methods to reduce detection overhead of messages in resource pools, such as the method 200 of FIG. 2, may be provided as described herein.

The computing device 300 may have additional features or functionality, and additional interfaces to facilitate communications between the basic configuration 302 and any required devices and interfaces. For example, a bus/interface controller 330 may be used to facilitate communications between the basic configuration 302 and one or more data storage devices 332 via a storage interface bus 334. The data storage devices 332 may be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer-readable instructions, data structures, program modules, or other data.

The system memory 306, removable storage devices 336, and non-removable storage devices 338 are examples of computer storage media or non-transitory computer-readable media. Computer storage media or non-transitory computer-readable media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which may be used to store the desired information and which may be accessed by the computing device 300. Any such computer storage media or non-transitory computer-readable media may be part of the computing device 300.

The computing device 300 may also include an interface bus 340 for facilitating communication from various interface devices (e.g., output devices 342, peripheral interfaces 344, and communication devices 346) to the basic configuration 302 via the bus/interface controller 330. Example output devices 342 include a graphics processing unit 348 and an audio processing unit 350, which may be configured to communicate to various external devices such as a display or speakers via one or more A/V ports 352. For example, at least some data transmitted to the computing device 300 via, e.g., the D2D communication 112 and/or the radio communication 110 of FIG. 1, may be communicated by the graphics processing unit 348 and/or the audio processing unit 350 via the A/V Port(s) 352 to the display or speakers for output to a user of the computing device 300.

Example peripheral interfaces 344 include a serial interface controller 354 or a parallel interface controller 356, which may be configured to communicate with external devices such as input devices (e.g., keyboard, mouse, pen, voice input device, touch input device) or other peripheral devices (e.g., printer, scanner) via one or more I/O ports 358. In some embodiments, the input devices may accept input from the user of the computing device 300, some of which may be transmitted as data by the computing device 300 via the D2D communication 112 and/or the radio communication 110 of FIG. 1 to one or more of the UEs 104 of FIG. 1.

The example communication device 346 may include a network controller 360, which may be arranged to facilitate communications with one or more other computing devices 362 over a network communication link via one or more communication ports 364. Alternatively or additionally, the example communication device 346 may include a cellular communications transceiver for sending and receiving data over a cellular communications network, such as via the D2D communication 112 and/or the radio communication 110 of FIG. 1

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media as used herein may include both storage media and communication media.

The computing device 300 may be implemented as a portion of a small-form factor portable (or mobile) electronic device such as a cell phone, a personal data assistant (PDA), a personal media player device, a wireless web-watch device, a personal headset device, an application-specific device, a terminal, a UE, or a hybrid device that includes any of the above functions. The computing device 300 may also be implemented as a personal computer including both laptop computer and non-laptop computer configurations.

The present disclosure is not to be limited in terms of the particular embodiments described herein, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the present disclosure is not limited to particular methods, reagents, compounds, compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present inventions have been described in detail, it should be understood that the various changes, substitutions, and alterations could be made hereto without departing from the spirit and scope of the invention.

What is claimed is:

1. A method comprising:
a first user equipment (UE) selecting one or more resource pools from a plurality of resource pools;
the first UE transmitting a resource usage indicator that identifies the one or more resource pools to a second UE; and
the first UE transmitting one or more device-to-device (D2D) communications to the second UE using the one or more resource pools.

2. The method of claim 1, further comprising the first UE:
receiving resource usage indicators from other UEs that identify resource pools via which the other UEs intend to send D2D communications to the first UE; and
estimating, based on the received resource usage indicators, loads of the plurality of resource pools;
wherein the first UE selecting comprises selecting the one or more resource pools from the plurality of resource pools in response to the one or more resource pools having an estimated load that is lower than estimated loads of others of the plurality of resource pools.

3. The method of claim 1, wherein the first UE transmitting the resource usage indicator comprises the first UE transmitting a D2D synchronization signal (D2DSS) that includes the resource usage indicator or the first UE transmitting a physical D2D synchronization channel (PD2DSCH) message that includes the resource usage indicator.

4. The method of claim 1, wherein the resource usage indicator comprises a bitmap that includes a plurality of bits and wherein each corresponding bit of the plurality of bits indicates whether a particular resource pool associated with the corresponding bit has been selected for use.

5. The method of claim 1, wherein:
the first UE selecting comprises selecting a D2D discovery resource pool from a set of D2D discovery resource pools;
the first UE transmitting the resource usage indicator that identifies the one or more resource pools comprises transmitting the resource usage indicator that identifies the D2D discovery resource pool; and
the first UE transmitting the one or more D2D communications to the second UE using the one or more resource pools comprises transmitting a D2D discovery message to the second UE using only the D2D discovery resource pool.

6. The method of claim 1, wherein:
the first UE selecting comprises selecting a D2D scheduling assignment (SA) resource pool from a set of D2D SA resource pools;
the first UE transmitting the resource usage indicator that identifies the one or more resource pools comprises transmitting the resource usage indicator that identifies the D2D SA resource pool; and
the first UE transmitting one or more D2D communications to the second UE using the one or more resource pools comprises transmitting a D2D SA message to the second UE using only the D2D SA resource pool.

7. The method of claim 6, wherein the D2D SA resource pool is associated with a D2D data resource pool of a plurality of D2D data resource pools, further comprising the first UE transmitting one or more D2D data transmissions to the second UE using only the D2D data resource pool.

8. The method of claim 1, further comprising:
the first UE receiving a second resource usage indicator from a third UE that identifies a resource pool via which the third UE intends to send D2D communications to the first UE; and
the first UE monitoring the resource pool for D2D communications from the third UE without monitoring resource pools that are not identified by the second resource usage indicator or not identified by other resource usage indicators received by the first UE from other UEs.

9. A method comprising:
receiving one or more resource usage indicators that identify one or more resource pools of a plurality of resource pools;
monitoring the one or more resource pools identified by the one or more resource usage indicators for device-to-device (D2D) communications from at least one user equipment (UE); and
not monitoring remaining resource pools of the plurality of resource pools that are not identified by the one or more resource usage indicators.

10. The method of claim 9, further comprising:
estimating loads of each of multiple resource pools of the plurality of resource pools that are available for D2D communications based on the one or more resource usage indicators;
selecting one or more of the multiple resource pools that has an estimated load that is lower than estimated loads of others of the multiple resource pools;
transmitting a resource usage indicator that identifies the one or more of the multiple resource pools to a D2D-receiving UE; and
transmitting one or more D2D communications to the D2D-receiving UE using the one or more of the multiple resource pools.

11. The method of claim 9, wherein receiving one or more resource usage indicators that identify one or more resource pools of a plurality of resource pools comprises receiving at least one D2D synchronization signal (D2DSS) or at least one physical D2D synchronization channel (PD2DSCH) that includes at least one of the one or more resource usage indicators.

12. The method of claim 9, wherein at least one of the one or more resource usage indicators comprises a bitmap that includes a plurality of bits and wherein each corresponding bit of the plurality of bits indicates whether a particular resource pool associated with the corresponding bit has been selected for use.

13. The method of claim 9, wherein:
the one or more resource pools identified by the one or more resource usage indicators comprise one or more D2D discovery resource pools of a plurality of D2D discovery resource pools;
the monitoring comprises monitoring the one or more D2D discovery resource pools for one or more D2D discovery messages from the at least one UE; and
the not monitoring comprises not monitoring remaining D2D discovery resource pools of the plurality of D2D discovery resource pools that are not identified by the one or more resource usage indicators.

14. The method of claim 9, wherein:
the one or more resource pools identified by the one or more resource usage indicators comprise one or more D2D scheduling assignment (SA) resource pools of a plurality of D2D SA resource pools;
the monitoring comprises monitoring the one or more D2D SA resource pools for one or more D2D SA messages from the at least one UE; and
the not monitoring comprises not monitoring remaining D2D SA resource pools of the plurality of D2D SA resource pools that are not identified by the one or more resource usage indicators.

15. The method of claim 14, wherein each of the one or more D2D SA resource pools of the plurality of D2D SA resource pools is associated in a one-to-one relationship with a corresponding one of one or more D2D data resource pools of a plurality of D2D data resource pools, the method further comprising:
monitoring the one or more D2D data resource pools for one or more D2D data transmissions from the at least one UE; and
not monitoring remaining D2D data resource pools of the plurality of D2D data resource pools.

16. A system comprising:
a first user equipment (UE) configured to:
select one or more resource pools from a plurality of resource pools;
transmit a resource usage indicator that identifies the one or more resource pools; and
transmit one or more device-to-device (D2D) communications using the one or more resource pools; and
a second UE configured to:
receive one or more resource usage indicators from one or more other UEs, the one or more resource usage indicators including the resource usage indicator from the first UE and the one or more other UEs including the first UE;
monitor resource pools identified by the one or more resource usage indicators for D2D communications from the one or more other UEs; and
not monitor remaining resource pools of the plurality of resource pools for D2D communications from the one or more other UEs.

17. The system of claim 16, wherein the one or more resource pools comprise a D2D discovery resource pool and the plurality of resource pools comprise a plurality of D2D discovery resource pools.

18. The system of claim 16, wherein the one or more resource pools comprise a D2D scheduling assignment (SA) resource pool and the plurality of resource pools comprise a plurality of D2D SA resource pools.

19. The system of claim 16, wherein the resource usage indicator comprises a bitmap that includes a plurality of bits and wherein each corresponding bit of the plurality of bits indicates whether a particular resource pool associated with the corresponding bit has been selected for use.

20. The system of claim 16, wherein the plurality of resource pools are selected for use in a particular order, and the resource usage indicator identifies a number of resource pools selected for use.
